(19) United States
(12) Patent Application Publication
(10) Pub. No.: US 2014/0329682 A1
(43) Pub. Date: Nov. 6, 2014

(54) METHOD OF CONTROLLING WEED IN A SUGAR CANE FIELD

(71) Applicant: SUMITOMO CHEMICAL COMPANY, LIMITED, Tokyo (JP)

(72) Inventor: Hajime Ikeda, Kasai-shi (JP)

(21) Appl. No.: 14/364,740

(22) PCT Filed: Dec. 7, 2012
(86) PCT No.: PCT/JP2012/082435

§ 371 Date: Jun. 12, 2014

(30) Foreign Application Priority Data
Dec. 15, 2011 (JP) 2011-274147

(51) Int. Cl. A01N 43/84; A01N 43/82; A01N 31/16; A01N 41/06; A01N 43/54; A01N 43/653

(52) U.S. Cl. CPC A01N 43/84; A01N 43/54; A01N 43/653; A01N 31/16; A01N 41/06; A01N 43/82
USPC 504/225; 504/243; 504/273; 504/352; 504/333; 504/265

(57) ABSTRACT

An object of the present invention is to provide a method which exerts the excellent controlling effect on a weed, without causing significant phytotoxicity on sugar cane, in a sugar cane field. According to the present invention, there is provided a method of controlling a weed in a sugar cane field, comprising applying one or more PPO-inhibiting compounds selected from the group consisting of flumioxazin, sulfentrazone saflufenacil, oxyfluorfen, fomesafen and a salt thereof oxadiazon and a compound of the formula (I): to a field before or after planting with a stem cutting of sugar cane having only one node.

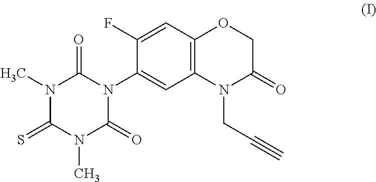 [SMILES: C#CCN1C(=O)COc2cc(F)c(-n3c(=O)n(C)c(=S)n(C)c3=O)cc21]

### TECHNICAL FIELD

The present invention relates to a method of controlling a weed.

### BACKGROUND ART

For controlling a weed, many compounds as an active ingredient of an agent for controlling a weed such as herbicides are known.

### CITATION LIST

### Patent Literature

Patent Document 1: U.S. Pat. No. 6,077,812
Patent Document 2: WO 09/000398
Patent Document 3: WO 09/000399
Patent Document 4: WO 09/000400
Patent Document 5: WO 09/000401
Patent Document 6: WO 09/000402
Patent Document 7: WO 02/066471

### Non Patent Literature

Non-Patent Document 1: Crop Protection Handbook, vol. 95 (2009)

### SUMMARY OF INVENTION

### Technical Problem

An object of the present invention is to provide a method which exerts the excellent controlling effect on a weed, without causing significant phytotoxicity on sugar cane, in a sugar cane field.

### Solution of Problem

The present invention is such that, when a field planted with a stem cutting of sugar cane having a specific length is treated with a PPO-inhibiting compound, the excellent controlling effect is exerted on a weed grown in a field, without causing significant phytotoxicity on sugar cane.

The present invention is as follows.

[1] A method of controlling a weed in a sugar cane field, comprising applying one or more PPO-inhibiting compounds selected from the group consisting of flumioxazin, sulfentrazone, saflufenacil, oxyfluorfen, fomesafen and a salt thereof, oxadiazon and a compound of the formula (I):

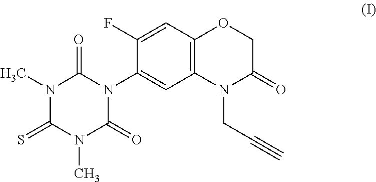 [SMILES: C#CCN1C(=O)COc2cc(F)c(-n3c(=O)n(C)c(=S)n(C)c3=O)cc21]

to a field before, at or after planting with a stem cutting of sugar cane having only one node.
[2] The method of controlling a weed according to [1], wherein the stem cutting of sugar cane is 2 cm to 15 cm length.
[3) The method of controlling a weed according to [1], wherein the stem cutting of sugar cane is 3 cm to 8 cm length.
[4] The method of controlling a weed according to any one of [1] to [3], wherein the PPO-inhibiting compound is flumioxazin.
[5] The method of controlling a weed according to any one of [1] to [3], wherein the PPO-inhibiting compound is saflufenacil.
[6] The method of controlling a weed according to any one of [1] to [3], wherein the PPO-inhibiting compound is sulfentrazone.

### Effect of Invention

According to the method of the present invention, a weed in a sugar cane field can be controlled without causing significant phytotoxicity on sugar cane.

In addition, according to the method of present invention, it becomes possible to increase the yield of sugar cane and the yield of sugar from a plant of sugar cane.

### DESCRIPTION OF EMBODIMENTS

The method of controlling a weed of the present invention includes steps of:

(1) planting a stem cutting of sugar cane having a specific length, and
(2) applying one or more PPO-inhibiting compounds selected from the group consisting of flumioxazin, sulfentrazone, saflufenacil, oxyfluorfen, fomesafen and a salt thereof, oxadiazon and a compound of the formula (I):

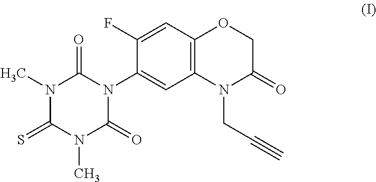 [SMILES: C#CCN1C(=O)COc2cc(F)c(-n3c(=O)n(C)c(=S)n(C)c3=O)cc21]

to a field.

Sugar cane used in the method of the present invention is a Saccharum perennial Poaceae crop, and examples include Saccharum arundinaceum, Saccharum bengalense, Saccharum edule, Saccharum officinarum, Saccharum procerum, Saccharum ravennae, Saccharum robustum, Saccharum sinense, Saccharum spontaneum and a hybrid of these species.

Sugar cane used in the method of the present invention is not limited as far as it is a variety which is generally cultivated as a crop.

Examples of the crop includes crops to which resistance to a 4-hydroxyphenylpyruvate dioxygenase inhibitor such as isoxaflutole; an acetolactate synthase (hereinafter abbreviated as ALS) inhibitor such as imazethapyr or thifensulfuron methyl; a 5-enolpyruvylshikimate-3-phosphate synthase (hereinafter, abbreviated as EPSP) inhibitor such as glyphosate; a glutamine synthase inhibitor such as glufosinate; an auxin-type herbicide such as 2,4-D or dicamba; or bromoxynil has been imparted by a classical breeding method or a genetic engineering technique.

The crop includes, for example, a crop which has become possible to synthesize a selective toxin known in Bacillus genus, using a genetic engineering technique.

Examples of the toxin which is expressed in such a genetically engineered plant include an insecticidal protein derived from Bacillus cereus or Bacillus popilliae; a 6-endotoxin such as Cry1Ab, Cry1Ac, Cry1F, Cry1Fa2, Cry2Ab, Cry3A, Cry3Bb1 or Cry9C, derived from Bacillus thuringiensis; an insecticidal protein such as VIP1, VIP2, VIP3 or VIP3A; an insecticidal protein derived from nematode; a toxin produced by an animal such as a scorpion toxin, a spider toxin, a bee toxin or an insect-specific neurotoxin; a filamentous fungus toxin; plant lectin; agglutinin; a protease inhibitor such as a trypsin inhibitor, a serine protease inhibitor, patatin, cystatin, and a papain inhibitor; a ribosome inactivating protein (RIP) such as lysine, corn-RIP, abrin, luffin, saporin or bryodin; a steroid metabolism enzyme such as 3-hydroxysteroid oxidase, ecdysteroid-UDP-glycosyltransferase, and cholesterol oxidase; an ecdysone inhibitor; HMG-CoA reductase; an ion channel inhibitor such as a sodium channel inhibitor or a calcium channel inhibitor; juvenile hormone esterase; a diuretic hormone receptor; stilbene synthase; bibenzyl synthase; chitinase; glucanase; and the like.

A toxin expressed by such a genetically engineered crop includes a hybrid toxin of a 6-endotoxin protein such as Cry1Ab, Cry1Ac, Cry1F, Cry1Fa2, Cry2Ab, Cry3A, Cry3Bb1, Cry9C, Cry34Ab or Cry35Ab, and an insecticidal protein such as VIP1, VIP2, VIP3 or VIP3A, and a partially deleted toxin, and a modified toxin. The hybrid toxin can be produced by a new combination of different domains of these proteins using a genetic engineering technique. As the partially deleted toxin, Cry1Ab in which a part of an amino acid sequence has been deleted is known. In the modified toxin, one or a plurality of amino acids of a natural toxin are substituted. Examples of these toxins and recombinant plants which can synthesize these toxins are described in EP-A-0374753, WO 93/07278, WO 95/34656, EP-A-0427529, EP-A-451878, WO 03/052073 and the like. The toxins contained in these recombinant plans impart resistance to Coleoptera vermin, Diptera vermin and Lepidoptera vermin to a plant.

The crop also includes a crop to which the ability to produce an anti-pathogenic substance having selective action has been imparted using a genetic engineering technique. As an example of the anti-pathogenic substance, a PR protein and the like are known (PRPs, EP-A-0392225). Such an anti-pathogenic substance and a genetically engineered plant producing the substance are described in EP-A-0392225, WO 95/33818, EP-A-0353191 and the like. Examples of the anti-pathogenic substance expressed in such a genetically engineered plant include an ion channel inhibitor such as a sodium channel inhibitor or a calcium channel inhibitor (KP1, KP4 and KP6 toxins, etc., which are produced by viruses, have been known); stilbene synthase; bibenzyl synthase; chitinase; glucanase; a PR protein; and an anti-pathogenic substance generated by microorganisms, such as a peptide antibiotic, an antibiotie having a hetero ring, or a protein factor associated with resistance to plant diseases (which is called a plant disease-resistant gene and is described in WO 03/000906).

The crop also includes crops to which disease resistance, drying stress resistance or a characteristic of increasing sugar content is imparted.

In commercial cultivation of sugar cane, a stem cutting having nodes with buds is usually planted. The term ‘stem cutting’ means a section of a stalk, which is a seed piece to propagate sugar cane. The term ‘node’ means the part of the stalk, where a bud and root primordia are found. The ‘bud’, located in a node, is an embryonic shoot consisting of a small stalk with small leaves.

In the method of the present invention, as a stem cutting of sugar cane, a stem cutting obtained by cutting a mature stalk of sugar cane so that the cutting has one node is used. The size of the stem cutting of sugar cane is desirably 2 cmto 15 cm, further more desirably 3 cm to 8 cm. The technique of cultivating sugar cane using the stem cutting is known in Patent Documents 2 to 6, and known under the brand name of Plene (trade mark).

The stem cutting of sugar cane used in the method of the present invention may be treated with an agrochemical such as an insecticide, a nematicide, a fungicide, a plant growth controlling agent and a safener, before planting.

Examples of the agrochemicals include the following:

Insecticides: clothianidin, thiamethoxam, imidacloprid, dinotefuran, nitenpyram, acetamiprid and thiacloprid, abmectin, fipronil, carbofuran.

Nematicide: fosthiazate.

Fungicides: kresoxim-methyl, azoxystrobin, trifloxystrobin, fluoxastrobin, picoxystrobin, pyraclostrobin, dimoxystrobin, pyribencarb, metominostrobin, orysastrobin, enestrobin, pyraoxystrobin, pyrametostrobin, azaconazole, bitertanol, bromuconazole, cyproconazole, difenoconazole, diniconazole, epoxiconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole fumarate, pefurazoate, prochloraz, triflumizole, metalaxyl and metalaxyl-M.

Plant growth controlling agents: hymexazol, paclobutrazol, uniconazole, uniconazole-P, inabenfide, prohexadione-calcium, 1-methylcyclopropene, trinexapac and gibberellins.

Safeners: benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride and oxabetrinil.

The PPO-inhibiting compound is a herbicidally active compound which inhibits protoporphyrinogen IX oxidase (EC1.3.3.4) located on a chlorophyll synthesis route in a plastid of a plant and, as a result, leads to withering of the plant.

The PPO-inhibiting compound used in the method of the present invention is flumioxazin, sulfentrazone, saflufenacil, oxyfluorfen, fomesafen and a salt thereof, oxadiazon, and a compound of the formula (I):

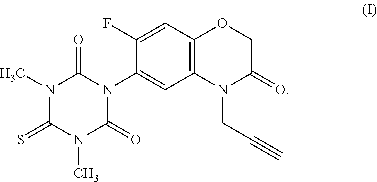 [SMILES: C#CCN1C(=O)COc2cc(F)c(-n3c(=O)n(C)c(=S)n(C)c3=O)cc21]

These are all herbicidally active compounds described in Crop Protection Handbook, vol. 97 (2011) or Patent Document 7, and can be produced by the known processes, and commercially available preparations-containing them can be obtained.

Fomesafen used in the method of the present invention may be a form of ah acid, or a salt such as a formesafen sodium salt (fomesafen-sodium).

In the step of treating a sugar cane field with the PPO-inhibiting compound, the PPO-inhibiting compound is mixed with a solid carrier or a liquid carrier, formulated with optional addition of an auxiliary agent for formulation such as a surfactant, and then used.

Examples of a method of treating a sugar cane field with the PPO-inhibiting compound include a method of spraying the PPO-inhibiting compound on a soil of a field and a method of spraying the PPO-inhibiting compound on a weed after development of the weed.

An amount of the PPO-inhibiting compound used in the step of treating a field with the PPO-inhibiting compound is usually 5 to 5000 g per 10000 m². In the step of treating a field with the PPO-inhibiting compound, an adjuvant may be mixed upon treatment with the PPO-inhibiting compound.

In the method of the present invention, a field may be treated with the PPO-inhibiting compound before planting of a stem cutting of sugar cane, may be treated with the PPO-inhibiting compound simultaneously at planting of a stem cutting of sugar cane, or may be treated with the PPO-inhibiting compound after planting of a stem cutting of sugar cane.

When a field is treated with the PPO-inhibiting compound before planting of a stem cutting of sugar cane, the field is treated with the PPQ compound 40 days before planting to immediately before planting, preferably 30 days before planting to immediately before planting, further preferably 20 days before planting to immediately before planting.

When a field is treated with the PPO-inhibiting compound after planting of a stem cutting of sugar cane, the field is treated with the PPO compound immediately after planting to 40 days after planting, preferably immediately after planting to 20 days after planting, further preferably immediately after planting to 10 days after planting.

According to the method of the present invention, a weed in a sugar cane field can be controlled.

Examples of the weed include the followings:

Urticaceae weeds: Urtica urens

Polygonaceae weeds: Polygonum convolvulus, Polygonum lapathifolium, Polygonum pensylvanicum, Polygonum persicaria, Polygonum longisetum, Polygonum aviculare, Polygonum arenastrum, Polygonum cuspidatum, Rumex japonicus, Rumex crispus, Rumex obtusifolius, Rumex acetosa

Portulacaceae weeds: Portulaca oleracea

Caryophyllaceae weeds: Stellaria media, Cerastium holosteoides, Cerastium glomeratum, Spergula arvensis, Silene gallica

Aizoaceae weeds: Mollugo verticillata

Chenopodiaceae weeds: Chenopodium album, Chenopodium ambrosioides, Kochia scoparia, Salsola kali, Atriplex spp.

Amaranthaceae weeds: Amaranthus retroflexus, Amaranthus viridis, Amaranthus lividus, Amaranthus spinosus, Amaranthus hybridus, Amaranthus palmeri, Amaranthus rudis, Amaranthus patulus, Amaranthus tuberculatos, Amaranthus blitoides, Amaranthus deflexus, Amaranthus quitensis, Alternanthera philoxeroides, Alternanthera sessilis, Alternanthera tenella

Papaveraceae weeds: Papaver rhoeas, Argemone mexicana

Brassicaceae weeds: Raphanus raphanistrum, Raphanus sativus, Sinapis arvensis, Capsella bursa-pastoris, Brassica juncea, Brassica campestris, Descurainia pinnata, Rorippa islandica, Rorippa sylvestris, Thlaspi arvense, Myagrum rugosum, Lepidium virginicum, Coronopus didymus

Capparaceae weeds: Cleome affinis

Fabaceae weeds: Aeschynomene indica, Aeschynomene rudis, Sesbania exaltata, Cassia obtusifolia, Cassia occidentalis, Desmodium tortuosum, Desmodium adscendens, Trifolium repens, Pueraria lobata, Vicia angustifolia, Indigofera hirsuta, Indigofera truxillensis, Vigna sinensis

Oxalidaceae weeds: Oxalis corniculata, Oxalis strica, Oxalis oxyptera

Geraniaceae weeds: Geranium carolinense, Erodium cicutarium

Euphorbiaceae weeds: Euphorbia helioscopia, Euphorbia maculata, Euphorbia humistrata, Euphorbia esula, Euphorbia heterophylla, Euphorbia brasiliensis, Acalypha australis, Croton glandulosus, Croton lobatus, Phyllanthus corcovadensis, Ricinus communis

Malvaceae weeds: Abutilon theophrasti, Sida rhombiforia, Sida cordifolia, Sida spinosa, Sida glaziovii, Sida santaremnensis, Hibiscus trionum, Anoda cristata, Malvastrum coromandelianum

Sterculiaceae weeds: Waltheria indica

Violaceae weeds: Viola arvensis, Viola tricolor

Cucurbitaceae weeds: Sicyos angulatus, Echinocystis lobata, Momordica charantia

Lythraceae weeds: Lythrum salicaria

Apiaceae weeds: Hydrocotyle sibthorpioides

Sapindaceae weeds: Cardiospermum halicacabum

Primulaceae weeds: Anagallis arvensis

Asclepiadaceae weeds: Asclepias syriaca, Ampelamus albidus

Rubiaceae weeds: Galium aparine, Galium spurium var. echinospermon, Spermacoce latifolia, Richardia brasiliensis, Borreria alata

Convolvulaceae weeds: Ipomoea nil, Ipomoea hederacea, Ipomoea purpurea, Ipomoea hederacea var. integriuscula, Ipomoea lacunosa, Ipomoea triloba, Ipomoea acuminata, Ipomoea hederifolia, Ipomoea coccinea, Ipomoea quamoclit, Ipomoea grandifolia, Ipomoea aristolochiafolia, Ipomoea cairica, Convolvulus arvensis, Calystegia hederacea, Calystegia japonica, Merremia hedeacea, Merremia aegyptia, Merremia cissoides, Jacquemontia tamnifolia

Boraginaceae weeds: Myosotis arvensis

Lamiaceae weeds: Lamium purpureum, Lamium amplexicaule, Leonotis nepetaefolia, Hyptis suaveolens, Hyptis lophanta, Leonurus sibiricus, Stachys arvensis

Solanaceae weeds: Datura stramonium, Solanum nigrum, Solanum americanum, Solanum ptycanthum, Solanum sarrachoides, Solanum rostratum, Solanum aculeatissimum, Solanum sisymbriifolium, Solanum carolinense, Physalis angulata, Physalis subglabrata, Nicandra physaloides

Scrophulariaceae weeds: Veronica hederaefolia, Veronica persica, Veronica arvensis

Plantaginaceae weeds: Plantago asiatica

Asteraceae weeds: Xanthium pensylvanicum, Xanthium occidentale, Helianthus annuus, Matricaria chamomilla, Matricaria perforata, Chrysanthemum segetum, Matricaria matricarioides, Artemisia princeps, Artemisia vulgaris, Artemisia verlotorum, Solidago altissima, Taraxacum officinale, Galinsoga ciliata, Galinsoga parviflora, Senecio vulgaris, Senecio brasiliensis, Senecio grisebachii, Conyza bonariensis, Conyza canadensis, Ambrosia artemisiaefolia, Ambrosia trifida, Bidens pilosa, Bidens frondosa, Bidens subalternans, Cirsium arvense, Cirsium vulgare, Silybum marianum, Carduus nutans, Lactuca serriola, Sonchus oleraceus, Sonchus asper, Wedelia glauca, Melampodium perfoliatum, Emilia sonchifolia, Tagetes minuta, Blainvillea latifolia, Tridax procumbens, Porophyllum ruderale, Acanthospermum australe, Acanthospermum hispidum, Cardiospermum halicacabum, Ageratum conyzoides, Eupatorium perfoliatum, Eclipta alba, Erechtites hieracifolia, Gamochaeta spicata, Gnaphalium spicatum, Jaegeria hirta, Parthenium hysterophorus, Siegesbeckia orientalis, Soliva sessilis

Liliaceae weeds: Allium canadense, Allium vineale

Commelinaceae weeds: Commelina communis, Commelina bengharensis, Commelina erecta

Poaceae weeds: Echinochloa crus-galli, Setaria viridis, Setaria faberi, Setaria glauca, Setaria geniculata, Digitaria ciliaris, Digitaria sanguinalis, Digitaria horizontalis, Digitaria insularis, Eleusine indica, Poa annua, Alospecurus aequalis, Alopecurus myosuroides, Avena fatua, Sorghum halepense, Sorghum vulgare, Agropyron repens, Lolium multiflorum, Lolium perenne, Lolium rigidum, Bromus secalinus, Bromus tectorum, Hordeum jubatum, Aegilops cylindrica, Phalaris arundinacea, Phalaris minor, Apera spica-venti, Panicum dichotomiflorum, Panicum texanum, Panicum maximum, Brachiaria platyphylla, Brachiaria ruziziensis, Brachiaria plantaginea, Brachiaria decumbens, Brachiaria brizantha, Brachiaria humidicola, Cenchrus echinatus, Cenchrus pauciflorus, Eriochloa villosa, Pennisetum setosum, Chloris gayana, Eragrostis pilosa, Rhynchelitrum repens, Dactyloctenium aegyptium, Ischaemum rugosum, Oryza sativa, Paspalum notatum, Paspalum maritimum, Pennisetum clandestinum, Pennisetum setosum, Rottboellia cochinchinensis

Cyperaceae weeds: Cyperus microiria, Cyperus iria, Cyperus odoratus, Cyperus rotundus, Cyperus esculentus, Kyllinga gracillima

Equisetaceae weeds: Equisetum arvense, Equisetum palustre etc.

In the method of the present invention, the PPO-inhibiting compound can be also applied by adding one or more kinds of other agrochemicals thereto. Examples of other agrochemical include an insecticide, a miticide, a nematocide, a fungicide, a herbicide, a plant regulating agent and a safener.

Examples of the herbicide, the plant growth regulating agent and the safener include the followings:

Herbicide: dicamba and a salt thereof (diglycolamine salt, dimethylammonium salt, isopropylammonium salt, potassium salt, sodium salt, choline salt), 2,4-D and a salt or ester thereof (butotyl ester, dimethylammonium salt, diolamine salt, ethylhexyl ester, isooctyl ester, isopropylammonium salt, sodium salt, triisopropanolamine salt, choline salt), 2,4-DB and a salt or ester thereof (dimethylammonium salt, isooctyl ester, choline salt), MCPA and a salt or ester thereof (dimethylammonium salt, 2-ethylhexyl ester, isooctyl ester, sodium salt, choline salt), MCPB, mecoprop and a salt or ester thereof (dimethylammonium salt, diolamine salt, ethadyl ester, 2-ethylhexyl ester, isooctyl ester, methyl ester, potassium salt, sodium salt, trolamine salt, choline salt), mecoprop-P and a salt or ester thereof (dimethylammonium salt, 2-ethylhexyl ester, isobutyl salt, potassium salt, choline salt), dichlorprop and a salt or ester thereof (butotyl ester, dimethylammonium salt, 2-ethylhexyl ester, isooctyl ester, methyl ester, potassium salt, sodium salt, choline salt), dichlorprop-P, dichlorprop-P-dimethylammonium, bromoxynil, bromoxynil-octanoate, dichlobenil, ioxynil, ioxynil-octanoate, di-allate, butylate, tri-allate, phenmedipham, chlorpropham, asulam, phenisopham, benthiocarb, molinate, esprocarb, pyributicarb, prosulfocarb, orbenCarb, EPTC, dimepiperate, swep, propachlor, metazachlor, alachlor, acetochlor, metolachlor, S-metolachlor, butachlor, pretilachlor, thenylchlor, aminocyclopyrachlor, aminocyclopyrachlor-methyl, aminocyclopyrachlor-potassium, trifluralin, pendimethalin, ethalfluralin, benfluralin, prodiamine, simazine, atrazine, propazine, cyanazine, ametryn, simetryn, dimethametryn, prometryn, indaziflam, triaziflam, metribuzin, hexazinone, isoxaben, diflufenican, diuron, linuron, fluometuron, difenoxuron, methyl-daimuron, isoproturon, isouron, tebuthiuron, benzthiazuron, methabenzthiazuron, propanil, mefenacet, clomeprop, naproanilide, bromobutide, daimuron, cumyluron, diflufenzopyr, etobenzanid, bentazon, tridiphane, indanofan, amitrole, fenchlorazole, clomazone, maleic hydrazide, pyridate, chloridazon, norflurazon, bromacil, terbacil, oxaziclomefone, cinmethylin, benfuresate, cafenstrole, pyrithiobac, pyrithiobac-sodium, pyriminobac, pyriminobac-methyl, bispyribac, bispyribac-sodium, pyribenzoxim, pyrimisulfan, pyriftalid, fentrazamide, dimethenamid, dimethenamid-P, ACN, bennzobicyclon, dithiopyr, triclopyr and a salt or ester thereof (butotyl ester, triethylammonium salt), fluroxypyr, fluroxypyr-meptyl, thiazopyr, aminopyralid and a salt thereof (potassium salt, triisopropanolammonium salt, choline salt), clopyralid and a salt thereof (olamine salt, potassium salt, triethylammonium salt, choline salt), picloram and a salt thereof (potassium salt, triisopropanolammonium salt, choline salt), dalapon, chlorthiamid, amidosulfuron, azimsulfuron, bensulfuron, bensulfuron-methyl, chlorimuron, chlorimuron-ethyl, cyclosulfamuron, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, mesosulfuron, mesosulfuron-methyl, nicosulfuron, orthosulfamuron, oxasulfuron, primisulfuron, primisulfuron-methyl, propyrisulfuron, pyrazosulfuron, pyrazosulfuron-ethyl, rimsulfuron, sulfometuron, sulfometuron-methyl, sulfosulfuron, trifloxysulfuron-sodium, trifloxysulfuron, chlorsulfuron, cinosulfuron, ethametsulfuron, ethametsulfuron-methyl, iodosulfuron, iodosulfuron-methyl-sodium, metsulfuron, metsulfuron-methyl, prosulfuron, thifensulfuron, thifensulfuron-methyl, triasulfuron, tribenuron, tribenuron-methyl, triflusulfuron, triflusulfuron-methyl, tritosulfuron, picolinafen, beflubutamid, mesotrione, sulcotrione, tefuryltrione, tembotrione, isoxachlortole, isoxaflutole, benzofenap, pyrasulfotole, pyrazolynate, pyrazoxyfen, topramezone, flupoxam, amicarbazone, bencarbazone, flucarbazone, flucarbazone-sodium, ipfencarbazone, propoxycarbazone, propoxycarbazone-sodium, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium, imazapic, imazapic-ammonium, imazapyr, imazapyr-ammonium, imazaquin, imazaquin-ammonium, imazethapyr, imazethapyr-ammonium, clodinafop, clodinafop-propargyl, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, propaquizafop, quizalofop, quizalofop-ethyl, quizalofop-P, quizalofop-P-ethyl, alloxydim, clethodim, sethoxydim, tepraloxydim, tralkoxydim, pinoxaden, pyroxasulfone, glyphosate, glyphosate-isopropylamine, glyphosate-trimethylsulfonium, glyphosate-ammonium, glyphosate-diammonium, glyphosate-sodium, glyphosate-potassium, glyphosate-guanidine, glufosinate, glufosinate-ammonium, glufosinate-P, glufosinate-P-sodium, bialafos, anilofos, bensulide, butamifos, paraquat, paraquat-dichloride, diquat anddiquat-dibromide

Plant growth regulating agents: hymexazol, paclobutrazol, uniconazole, uniconazole-P, inabenfide, prohexadione-calcium, 1-methylcyclopropene, trinexapac and gibberellins.

Safeners: benoxacor, cloquintocet, cloquintocet-mexyl, cyometrinil, cyprosulfamide, dichlormid, dicyclonon, dietholate, fenchlorazole, fenchlorazole-ethyl, fenclorim, flurazole, fluxofenim, furilazole, isoxadifen, isoxadifen-ethyl, mefenpyr, mefenpyr-diethyl, mephenate, naphthalic anhydride and oxabetrinil.

### Examples

The present invention will be described below by way of examples, but the present invention is not limited to these examples. In the following description, “ha” means hectare, that is, 10000 m².

First, evaluation criteria of the herbicidal activity and phytotoxicity will be shown.

### [Herbicidal Activity and Phytotoxicity]

Evaluation of herbicidal activity is classified into 0 to 100, letting no or little difference when the state of germination or growth of a test weed at investigation is compared with that of non-treatment to be “0”, and letting complete withering of a test plant or complete inhibition of germination or growth to be “100”.

Evaluation of phytotoxicity on a crop is classified into 0 to 100, letting no or little difference when the state of growth of a crop at investigation is compared with that of non-treatment to be “0”, and letting complete withering of a crop to be “100”. The “phytotoxicity” evaluated herein is the damage characteristic determined to be due to a treated compound, and is clearly discriminated from the damage characteristic caused by a harmful animal or plant disease.

### Example 1

A 30 cm to 40 cm stem cutting of sugar cane was placed on a wet soil, and germination was stimulated. The stem cutting from which a bud had grown to about 1 cm was selected, and the length of the stem cutting was adjusted to be 3 cm, 15 cm or 25 cm. The stem cutting of 3 cm or 15 cm had only one node, and the stem cutting of 25 cm had two nodes. A soil was packed into a 32 cm×25 cm×11 cm plastic pot, and seeds of Amaranthus retroflexus were seeded thereon. The stem cutting of sugar cane, having the adjusted length of 3 cm, 15 cm or 25 cm, was planted in the soil packed into the pot at a depth of 2 cm. On the date when the stem cutting was planted, and after planting of the stem cutting, a water-diluted liquid of a flumioxazin water dispersible granule (water dispersible granule containing 51% floumioxazin, trade name: Valor SX, manufactured by Valent USA Corporation) (100 ppm or 250 ppm) was uniformly sprayed on the soil surface with a sprayer at an amount described in Table 1. Thereafter, the pot for a test was placed in a greenhouse. Four weeks after treatment with flumioxazin, phytotoxicity on sugar cane and the herbicidal activity against Amaranthus retroflexus were determined. The results are shown in Table 1.

TABLE 1

| PPO-inhibiting | Length of stem cutting | Herbicidal | Phytotoxicity on |
|---|---|---|---|
| compound | of sugar cane | activity | sugar cane |
| Flumioxazin | 3 cm | 100 | 0 |
| 50 g (active | 15 cm | 100 | 5 |
| ingredient)/ha | 25 cm | 100 | 20 |
| Flumioxazin | 3 cm | 100 | 0 |
| 125 g (active | 15 cm | 100 | 5 |
| ingredient)/ha | 25 cm | 100 | 20 |

### Example 2

A 30 cm to 40 cm stem cutting of sugar cane was placed on a wet soil, and germination was stimulated. A sugar cane, a foliage of which had grown to about 4 to 5 leaves, was selected, and the length of the stem cutting was adjusted to be 8 cm, 15 cm or 25 cm. The 8 cm or 15 cm stem cutting had one node, and the 25 cm stem cutting had two nodes. A soil was packed into a 32 cm×25 cm×11 cm plastic pot, and seeds of Amaranthus retroflexus were seeded thereon. The stem cutting of sugarcane, the length of which had been adjusted to be 8 cm, 15 cm or 25 cm as described above, was planted in the soil packed into the pot at a depth of 2 cm. On the date when the stem cutting was planted, and after planting of the stem cutting, a water-diluted liquid of a flumioxazin water dispersible granule (water dispersible granule containing 51% flumioxazin, trade name: Valor SX, manufactured by Valent USA Corporation) (250 ppm) was uniformly sprayed with a sprayer from an upper side of the pot at an amount described in Table 2. Thereafter, the pot for a test was placed in a greenhouse. One week after treatment with flumioxazin, phytotoxicity on sugar cane was determined and, four weeks after treatment with flumioxazin, the herbicidal activity against Amaranthus retroflexus was determined. Results are shown in Table 2.

TABLE 2

| PPO-inhibiting | Length of stem cutting | Herbicidal | Phytotoxicity |
|---|---|---|---|
| compound | of sugar cane | activity | on sugar cane |
| Flumioxazin 125 g | 8 cm | 100 | 10 |
| (active | 15 cm | 100 | 10 |
| ingredient)/ha | 25 cm | 100 | 30 |

### Example 3

A 30 cm to 40 cm stem cutting of sugar cane was placed on a wet soil, and germination was stimulated. A sugar cane, a foliage of which had grown to about 4 to 5 leaves, was selected, and the length of the stem cutting was adjusted to be 8 cm or 25 cm. The 8 cm stem cutting had one node, and the 25 cm stem cutting had two nodes. A soil was packed into a 32 cm×25 cm×11 cm plastic pot, and seeds of Amaranthus retroflexus were seeded thereon. The stem cutting of sugarcane, the length of which had been adjusted to be 8 cm or 25 cm as described above, was planted in the soil packed into the pot at a depth of 2 cm. On the date when the stem cutting was planted, and after planting of the stem cutting, a water-diluted liquid of saflufenacil (140 ppm) was uniformly sprayed with a sprayer from an upper side of the pot at an amount described in Table 3. The water-diluted liquid of saflufenacil was prepared by dissolving a predetermined amount of saflufenacil in acetone containing 2% (w/v) Tween 20, and diluting this solution with water so that the acetone concentration became 10% by volume. Thereafter, the pot for a test was placed in a greenhouse. One week after treatment with saflufenacil, phytotoxicity on sugar cane was determined and, four weeks after treatment with saflufenacil, the herbicidal activity against Amaranthus retroflexus was determined. Results are shown in Table 3.

TABLE 3

| PPO-inhibiting | Length of stem cutting | Herbicidal | Phytotoxicity |
|---|---|---|---|
| compound | of sugar cane | activity | on sugar cane |
| Saflufenacil 70 g | 8 cm | 100 | 0 |
| (active | 25 cm | 100 | 15 |
| ingredient)/ha | | | |

### Example 4

A 30 cm to 40 cm stem cutting of sugar cane is placed on a wet soil, and germination is stimulated. The stem cutting from which a bud has grown to about 1 cm is selected, and the length of the stem cutting is adjusted to be 3 cm so that the stem cutting has one node. A soil is packed into a plastic pot, and seeds of Amaranthus retroflexus are seeded thereon. The stem cutting of sugar cane is planted in the soil packed in the pot at a depth of 2 cm. On the date when the stem cutting is planted, and after planting of the stem cutting, saflufenacil, sulfentrazone, oxyfluorfen, fomesafen, a fomesafen sodium salt, oxadiazon or a compound of the formula (I) is uniformly sprayed on the soil surface with a sprayer. Thereafter, the pot for a test is placed in a greenhouse. Four weeks after treatment with saflufenacil, sulfentrazone, oxyfluorfen, fomesafen, a fomesafen sodium salt, oxadiazon or a compound of the formula (I), the herbicidal activity against Amaranthus retroflexus and phytotoxicity are determined. As a result, significant phytotoxicity on sugar cane is not observed, and the controlling effect on a weed can be confirmed.

### Example 5

A soil is packed into a plastic pot, and seeds of Amaranthus retroflexus are seeded thereon. Thereafter, the pot is placed in a greenhouse, and the weed is grown. Three weeks after seeding of the weed, flumioxazin, saflufenacil, sulfentrazone, oxyfluorfen, fomesafen, a fomesafen sodium salt, oxadiazon or a compound of the formula (I) is uniformly sprayed with a sprayer from above the weed.

A 30 cm to 40 cm stem cutting of sugar cane is placed on a wet soil, and germination is stimulated. The stem cutting from which a bud has been grown to about 1 cm is selected, and the length of the stem cutting is adjusted to be 3 cm so that the stem cutting has one node.

One week after treatment with flumioxazin, saflufenacil, sulfentrazone, oxyfluorfen, fomesafen, a fomesafen sodium salt, oxadiazon or a compound of the formula (I), the stem cutting of sugar cane is planted in the pot treated with flumioxazin, saflufenacil, sulfentrazone, oxyfluorfen, fomesafen, a fomesafen sodium salt, oxadiazon or a compound of the formula (I) at a depth of 2 cm. The pot for a test is placed in a greenhouse.

Four weeks after treatment with flumioxazin, saflufenacil, sulfentrazone, oxyfluorfen, fomesafen, a fomesafen sodium salt, oxadiazon or a compound of the formula (I), the herbicidal activity against Amaranthus retroflexus and phytotoxicity are determined. As a result, significant phytotoxicity on sugar cane is not found, and the controlling effect on a weed can be confirmed.

### Example 6

A 30 cm to 40 cm stem cutting of sugar cane is placed on a wet soil, and germination is stimulated. The stem cutting from which a bud has grown to about 1 cm is selected, and the length of the stem cutting is adjusted to be 3 cm so that the stem cutting has one node. Clothianidin, thiamethoxiam, imidacloprid, dinotefuran, nitenpyram, acetamiprid or thiacloprid is adhered to the stem cutting. A soil is packed into a plastic pot, and seeds of Amaranthus retroflexus are seeded thereon. The stem cutting of sugar cane treated with clothianidin, thiamethoxiam, imidacloprid, dinotefuran, nitenpyram, acetamiprid or thiacloprid is planted in the soil packed into the pot at a depth of 2 cm. On the date when the stem cutting is planted, and after planting of the stem cutting, flumioxazin, saflufenacil, sulfentrazone, oxyfluorfen, fomesafen, a fomesafen sodium salt, oxadiazon or a compound of the formula (I) is uniformly sprayed on the soil surface with a sprayer. Thereafter, the pot for a test is placed in a greenhouse. Four weeks after treatment with flumioxazin, saflufenacil, sulfentrazone, oxyfluorfen, fomesafen, a fomesafen sodium salt, oxadiazon or a compound of the formula (I), herbicidal activity against Amaranthus retroflexus and phytotoxicity are determined. As a result, significant phytotoxicity on sugar cane is not observed, and the controlling effect on a weed can be confirmed.

### Example 7

A soil is packed into a plastic pot, and seeds of Amaranthus retroflexus are seeded thereon. Thereafter, the pot is placed in a greenhouse, and the weed is grown. Three weeks after seeding of the weed, flumioxazin, saflufenacil, sulfentrazone, oxyfluorfen, fomesafen, a fomesafen sodium salt, oxadiazon or a compound of the formula (I) is uniformly sprayed with a sprayer from above the weed.

A 30 cm to 40 cm stem cutting of sugar cane is placed on a wet soil, and germination is stimulated. The stem cutting from which a bud has grown to about 1 cm is selected, and the length of the stem cutting is adjusted to be 3 cm so that the stem cutting has one node. Clothianidin, thiamethoxiam, imidacloprid, dinotefuran, nitenpyram, acetamiprid or thiacloprid is adhered to the stem cutting.

One week after treatment with flumioxazin, saflufenacil, sulfentrazone, oxyfluorfen, fomesafen, a fomesafen sodium salt, oxadiazon or a compound of the formula (I), the stem cutting of sugar cane treated with clothianidin, thiamethoxiam, imidacloprid, dinotefuran, nitenpyram, acetamiprid or thiacloprid is planted in the pot treated with flumioxazin, saflufenacil, sulfentrazone, oxyfluorfen, fomesafen, a fomesafen sodium salt, oxadiazon or a compound of the formula (I) at a depth of 2 cm. The pot for a test is placed in a greenhouse.

Four weeks after treatment with flumioxazin, saflufenacil, sulfentrazone, oxyfluorfen, fomesafen, a fomesafen sodium salt, oxadiazon or a compound of the formula (I), the herbicidal activity against Amaranthus retroflexus and phytotoxicity are determined. As a result, significant phytotoxicity on sugar cane is not observed, and the controlling effect on a weed can be confirmed.

### Example 8

A 30 cm to 40 cm stem cutting of sugar cane is placed on a wet soil, and germination is stimulated. The stem cutting from which a bud has grown to about 1 cm is selected, and the length of the stem cutting is adjusted to be 3 cm so that the stem cutting has one node. Kresoxim-methyl, azoxystrobin, trifloxystrobin, fluoxastrobin, picoxystrobin, pyraclostrobin, dimoxystrobin, pyribencarb, metominostrobin, orysastrobin, enestrobin, pyraoxystrobin or pyrametostrobin is adhered to the stem cutting. A soil is packed into a plastic pot, and seeds of Amaranthus retroflexus are seeded thereon. The stem cutting of sugar cane treated with kresoxim-methyl, azoxystrobin, trifloxystrobin, fluoxastrobin, picoxystrobin, pyraclostrobin, dimoxystrobin, pyribencarb, metominostrobin, orysastrobin, enestrobin, pyraoxystrobin or pyrametostrobin is planted in the soil packed into the pot at a depth of 2 cm. On the date when the stem cutting is planted, and after planting of the stem cutting, flumioxazin, saflufenacil, sulfentrazone, oxyfluorfen, fomesafen, a fomesafen sodium salt, oxadiazon or a compound of the formula (I) is uniformly sprayed on the soil surface with a sprayer. Thereafter, the pot for a test is placed in a greenhouse. Four weeks after treatment with flumioxazin, saflufenacil, sulfentrazone, oxyfluorfen, fomesafen, a fomesafen sodium salt, oxadiazon or a compound of the formula (I), the herbicidal activity against Amaranthus retroflexus and phytotoxicity are determined. As a result, significant phytotoxicity on sugar cane is not observed, and the controlling effect on a weed can be confirmed.

### Example 9

A soil is packed into a plastic pot, and seeds of Amaranthus retroflexus are seeded thereon. Thereafter, the pot is placed in a greenhouse, and the weed is grown. Three weeks after seeding of the weed, flumioxazin, saflufenacil, sulfentrazone, oxyfluorfen, fomesafen, a fomesafen sodium salt, oxadiazon or a compound of the formula (t) is uniformly sprayed with a sprayer from above the weed.

A 30 cm to 40 cm stem cutting of sugar cane is placed on a wet soil, and germination is stimulated. The stem cutting from which a bud has grown to about 1 cm is selected, and the length of the stem cutting is adjusted to be 3 cm so that the stem cutting has one node. Kresoxim-methyl, azoxystrobin, trifloxystrobin, fluoxastrobin, picoxystrobin, pyraclostrobin, dimoxystrobin, pyribencarb, metominostrobin, orysastrobin, enestrobin, pyraoxystrobin or pyrametostrobin is adhered to the stem cutting.

One week after treatment with flumioxazin, saflufenacil, sulfentrazone, oxyfluorfen, fomesafen, a fomesafen sodium salt, oxadiazon or a compound of the formula (I), the stem cutting of sugar cane treated with Kresoxim-methyl, azoxystrobin, trifloxystrobin, fluoxastrobin, picoxystrobin, pyraclostrobin, dimoxystrobin, pyribencarb, metominostrobin, orysastrobin, enestrobin, pyraoxystrobin or pyrametostrobin is planted in the soil packed into the pot treated with flumioxazin, saflufenacil, sulfentrazone, oxyfluorfen, fomesafen, a fomesafen sodium salt, oxadiazon or a compound of the formula (I) at a depth of 2 cm. The pot for a test is placed in a greenhouse.

Four weeks after treatment with flumioxazin, saflufenacil, sulfentrazone, oxyfluorfen, fomesafen, a fomesafen sodium salt, oxadiazon or a compound of the formula (I), the herbicidal activity against Amaranthus retroflexus and phytotoxicity are determined. As a result, significant phytotoxicity on sugar cane is not observed, and the controlling effect on a weed can be confirmed.

### Example 10

A 30 to 40 cm stem cutting of sugar cane is placed on a wet soil, and germination is stimulated. The stem cutting from which a bud has grown to about 1 cm is selected, and the length of the stem cutting is adjusted to be 3 cm so that the stem cutting has one node. Azaconazole, bitertanol, bromoconazole, cyproconazole, difenoconazole, diniconazole, epoxyconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole fumarate, pefurazoate, procloraz or triflumizole is adhered to the stem cutting. A soil is packed into a plastic pot, and seeds of Amaranthus retroflexus are seeded thereon. The stem cutting of sugar cane treated with azaconazole, bitertanol, bromoconazole, cyproconazole, difenoconazole, diniconazole, epoxyconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole fumarate, pefurazoate, procloraz or triflumizole is planted in the soil packed into the pot at a depth of 2 cm. On the date when the stem cutting is planted, and after planting of the stem cutting, flumioxazin, saflufenacil, sulfentrazone, oxyfluorfen, fomesafen, a fomesafen sodium salt, oxadiazon or a compound of the formula (I) is uniformly sprayed on the soil surface with a sprayer. Thereafter, the pot for a test is placed in a greenhouse. Four weeks after treatment with flumioxazin, saflufenacil, sulfentrazone, oxyfluorfen, fomesafen, a fomesafen sodium salt, oxadiazon or a compound of the formula (I), the herbicidal activity against Amaranthus retroflexus and phytotoxicity are determined. As a result, significant phytotoxicity on sugar cane is not observed, and the control effect on a weed can be confirmed.

### Example 11

A soil is packed into a plastic pat, and seeds of Amaranthus retroflexus are seeded thereon. Thereafter, the pot is placed in a greenhouse, and the weed is grown. Three weeks after seeding of the weed, flumioxazin, saflufenacil, sulfentrazone, oxyfluorfen, fomesafen, a fomesafen sodium salt, oxadiazon or a compound of the formula (I) is uniformly sprayed with a sprayer from above the weed.

A 30 cm to 40 cm stem cutting of sugar cane is placed on a wet soil, and germination is stimulated. The stem cutting from which a bud has grown to about 1 cm is selected, and the length of the stem cutting is adjusted to be 3 cm so that the stem cutting has one node. Azaconazole, bitertanol, bromoconazole, cyproconazole, difenoconazole, diniconazole, epoxyconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole fumarate, pefurazoate, procloraz or triflumizole is adhered to the stem cutting.

One week after treatment with flumioxazin, saflufenacil, sulfentrazone, oxyfluorfen, fomesafen, a fomesafen sodium salt, oxadiazon or a compound of the formula (I), the stem cutting of sugar cane treated with azaconazole; bitertanol, bromoconazole, cyproconazole, difenoconazole, diniconazole, epoxyconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole fumarate, pefurazoate, procloraz or triflumizole is planted in the soil packed into the pot treated with flumioxazin, saflufenacil, sulfentrazone, oxyfluorfen, fomesafen, a fomesafen sodium salt, oxadiazon or a compound of the formula (I) at a depth of 2 cm. The pot for a test is placed in a greenhouse.

Four weeks after treatment with flumioxazin, saflufenacil, sulfentrazone, oxyfluorfen, fomesafen, a fomesafen sodium salt, oxadiazon or a compound of the formula (I), the herbicidal activity against Amaranthus retroflexus and phytotoxicity are determined. As a result, significant phytotoxicity on sugar cane is not observed, and the controlling effect on a weed can be confirmed.

### Example 12

A 30 cm to 40 cm stem cutting of sugar cane is placed on a wet soil, and germination is stimulated. The stem cutting from which a bud has grown to about 1 cm is selected, and the length of the stem cutting is adjusted to be 3 cm so that the stem cutting has one node. Metalaxyl or metalaxyl-M is adhered to the stem cutting. A soil is packed into a plastic pot. Seeds of Amaranthus retroflexus are seeded thereon. The stem cutting of sugar cane treated with metalaxyl or metalaxyl-M is planted in the soil packed into the pot at a depth of 2 cm. On the day when the stem cutting is planted, and after planting of the stem cutting, flumioxazin, saflufenacil, sulfentrazone, oxyfluorfen, fomesafen, a fomesafen sodium salt, oxadiazon or a compound of the formula (I) is uniformly sprayed on the soil surface with a sprayer. Thereafter, the pot for a test is placed in a greenhouse. Four weeks after treatment with flumioxazin, saflufenacil, sulfentrazone, oxyfluorfen, fomesafen, a fomesafen sodium salt, oxadiazon or a compound of the formula (I), the herbicidal activity against Amaranthus retroflexus and phytotoxicity are determined. As a result, significant phytotoxicity on sugar cane is not observed, and the controlling effect on a weed can be confirmed.

### Example 13

A soil is packed into a plastic pot, and seeds of Amaranthus retroflexus are seeded thereon. Thereafter, a pot is placed in a greenhouse, and the weed is grown. Three weeks after seeding of the weed, flumioxazin, saflufenacil, sulfentrazone, oxyfluorfen, fomesafen, a fomesafen sodium salt, oxadiazon or a compound of the formula (I) is uniformly sprayed with a sprayer from above the weed.

A 30 cm to 40 cm stem cutting of sugar cane is placed on a wet soil, and germination is stimulated. The stem cutting from which a bud has grown to about 1 cm is selected, and the length of the stem cutting is adjusted to be 3 cm so that the stem cutting has one node. Metalaxyl or metalaxyl-M is adhered to the stem cutting.

One week after treatment with flumioxazin, saflufenacil, sulfentrazone, oxyfluorfen, fomesafen, a fomesafen sodium salt, oxadiazon or a compound of the formula (I), the stem cutting of sugar cane treated with metalaxyl or metalaxyl-M is planted in the soil packed into the pot treated with flumioxazin, saflufenacil, sulfentrazone, oxyfluorfen, fomesafen, a fomesafen sodium salt, oxadiazon or a compound of the formula (I) at a depth of 2 cm. The pot for a test is placed in a greenhouse.

Four weeks after treatment with flumioxazin, saflufenacil, sulfentrazone, oxyfluorfen, fomesafen, a fomesafen sodium salt, oxadiazon or a compound of the formula (I), the herbicidal activity against Amaranthus retroflexus and phytotoxicity are determined. As a result, significant phytotoxicity on sugar cane is not observed, and the controlling effect on a weed can be confirmed.

### INDUSTRIAL APPLICABILITY

According to the method of the present invention, a weed, in a sugar cane field can be controlled, without causing significant phytotoxicity on sugar cane.

In addition, according to the method of present invention, it becomes possible to increase the yield of sugar cane and the yield of sugar from a plant of sugar cane.

1. A method of controlling a weed in a sugar cane field, comprising applying one or more PPO-inhibiting compounds selected from the group consisting of flumioxazin, sulfentrazone, saflufenacil, oxyfluorfen, fomesafen and a salt thereof, oxadiazon and a compound of the formula (I): 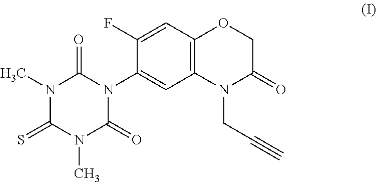 [SMILES: C#CCN1C(=O)COc2cc(F)c(-n3c(=O)n(C)c(=S)n(C)c3=O)cc21]
to a field before, at or after planting with a stem cutting of sugar cane having only one node.

2. The method of controlling a weed according to claim 1, wherein the stem cutting of sugar cane is 2 cm to 15 cm length.

3. The method of controlling a weed according to claim 1, wherein the stem cutting of sugar cane is 3 cm to 8 cm length.

4. The method of controlling a weed according to claim 1, wherein the PPO-inhibiting compound is flumioxazin.

5. The method of controlling a weed according to claim 1, wherein the PPO-inhibiting compound is saflufenacil.

6. The method of controlling a weed according to claim 1, wherein the PPO-inhibiting compound is sulfentrazone.

7. The method of controlling a weed according to claim 2, wherein the PPO-inhibiting compound is flumioxazin.

8. The method of controlling a weed according to claim 3, wherein the PPO-inhibiting compound is flumioxazin.

9. The method of controlling a weed according to claim 2, wherein the PPO-inhibiting compound is saflufenacil.

10. The method of controlling a weed according to claim 3, wherein the PPO-inhibiting compound is saflufenacil.

11. The method of controlling a weed according to claim 2, wherein the PPO-inhibiting compound is sulfentrazone.

12. The method of controlling a weed according to claim 3, wherein the PPO-inhibiting compound is sulfentrazone.
